(19) United States
(12) Patent Application Publication
(10) Pub. No.: US 2019/0033658 A1
(43) Pub. Date: Jan. 31, 2019

(54) LIQUID CRYSTAL DISPLAY MODULE

(71) Applicant: ADVANCED OPTOELECTRONIC TECHNOLOGY, INC., Hsinchu Hsien (TW)

(72) Inventors: HSIN-CHIANG LIN, Hukou (TW); CHIEN-CHENG KUO, Hukou (TW); PIN-CHUAN CHEN, Hukou (TW); LUNG-HSIN CHEN, Hukou (TW); WEN-LIANG TSENG, Hukou (TW)

(21) Appl. No.: 15/662,087

(22) Filed: Jul. 27, 2017

(51) Int. Cl. G02F 1/1335; G02F 1/1368

(52) U.S. Cl. CPC G02F 1/133603; G02F 1/1368; G02F 2001/133612; G02F 1/133605; G02F 2001/133614; G02F 1/133514

(57) ABSTRACT

A liquid crystal display module comprises a thin film transistor array substrate, a liquid crystal layer, a color filter substrate and a plurality of light emitting diode chips. The thin film transistor array substrate has a first surface and a second surface. A circuit structure is formed on the first surface. A plurality of thin film transistors is formed on the second surface and electrically connecting to the circuit structure. The liquid crystal layer faces the second surface. The liquid crystal layer is formed between the thin film transistor array substrate and the color filter substrate. The light emitting diode chips are adhered on the first surface and electrically connecting to the circuit structure. Each light emitting diode chip has a light emitting surface. Light emitted from the light emitting surfaces is incident on the first surface of the thin film transistor array substrate.

### FIELD

The subject matter herein generally relates to displays, and a light crystal display module.

### BACKGROUND

Generally, a liquid crystal display module includes a light source and a liquid crystal display panel. Light emitted from the light source is incident on the liquid crystal display panel. The light source and the liquid crystal display panel are two independent components. The liquid crystal display module with the light source and the liquid crystal display panel has a large thickness. Reducing the thickness of a liquid crystal display module has been problematic.

### BRIEF DESCRIPTION OF THE DRAWINGS

Implementations of the present technology will now be described, by way of example only, with reference to the attached figures.

FIG. 1 is a cross section view of a liquid crystal display module according to a first exemplary embodiment of the present disclosure.

FIG. 2 is a cross section view of a liquid crystal display module according to a second exemplary embodiment of the present disclosure.

FIG. 3 is a cross section view of a liquid crystal display module according to a third exemplary embodiment of the present disclosure.

FIG. 4 is a cross section view of a liquid crystal display module according to a fourth exemplary embodiment of the present disclosure.

FIG. 5 is a cross section view of a liquid crystal display module according to a fifth exemplary embodiment of the present disclosure.

FIG. 6 is a cross section view of a liquid crystal display module according to a sixth exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

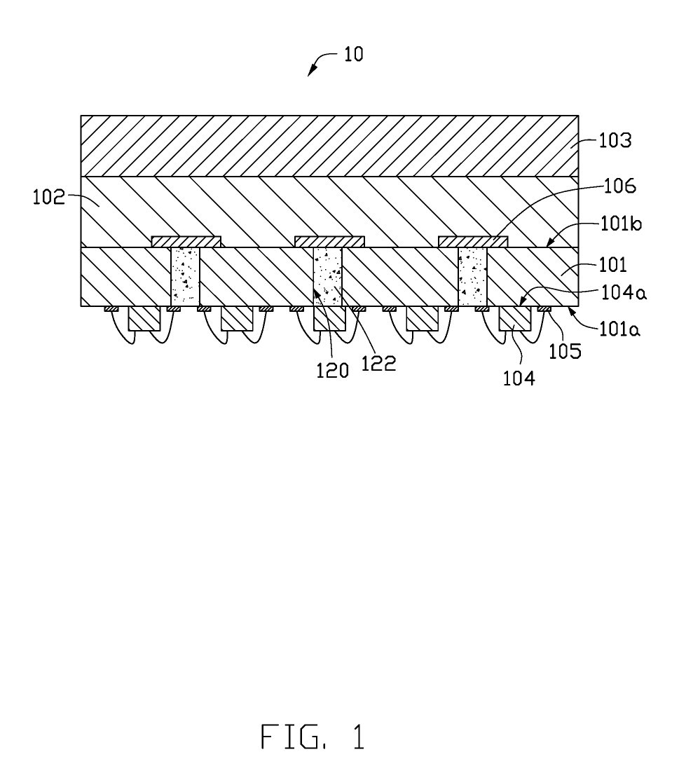

Referring to FIG. 1, a liquid crystal display module 10 is provided. The liquid crystal display module 10 comprises a thin film transistor array substrate 101, a liquid crystal layer 102, a color filter substrate 103, and a plurality of light emitting diode chips 104. The liquid crystal layer 102 is formed between the thin film transistor array substrate 101 and the color filter substrate 103.

The thin film transistor array substrate 101 has a first surface 101a and a second surface 101b. The thin film transistor array substrate 101 comprises a circuit structure 105 and a plurality of thin film transistors 106. The circuit structure 105 is formed on the first surface 101a. The thin film transistors 106 are formed on the second surface 101b. The circuit structure 105 electrically connects to the thin film transistors 106. In at least one embodiment, the circuit structure 105 can electrically connect to the thin film transistors 106 through wires (not shown). In other embodiments, a plurality of holes (not shown) can be defined in the thin film transistor array substrate and can receive conductors (not shown) for electrically connecting the circuit structure 105 and the thin film transistors 106.

The first surface 101a faces the light emitting diode chips 104. The second surface 101b faces the liquid crystal layer 102. The light emitting diode chips 104 are adhered on the first surface 101a. Each light emitting diode chip 104 has a light emitting surface 104a. Light emitted from the light emitting surfaces 104a of the light emitting diode chips 104 is incident on the first surface 101a of the thin film transistor array substrate 101.

In at least one embodiment, each light emitting surface 104a of the light emitting diode chip 104 faces the first surface 101a. Each light emitting diode chip 104 is electrically connected to the circuit structure 105 by wire bonding.

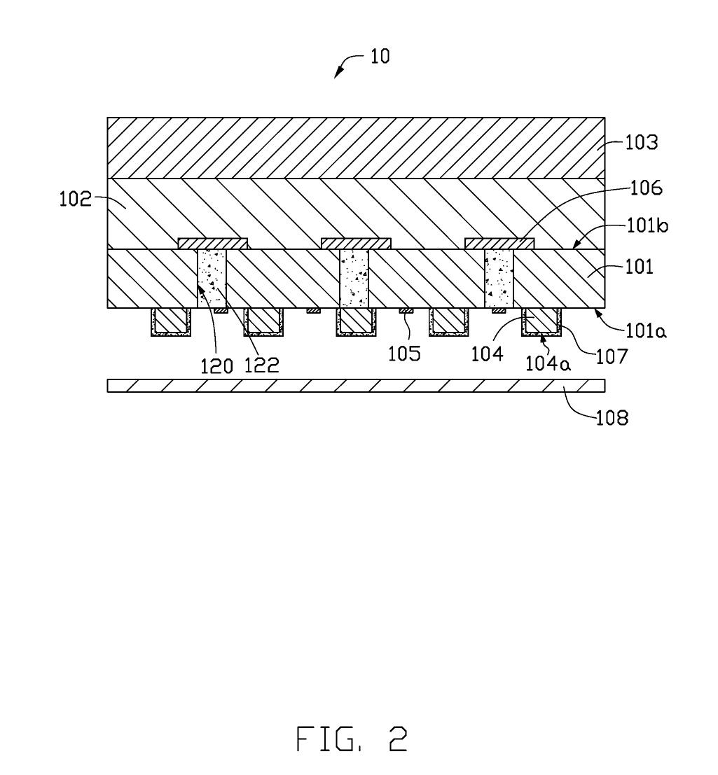

In at least one embodiment, referring to FIG. 2, the liquid crystal display module 10 of FIG. 2 differs from the liquid crystal display module 10 of FIG. 1 as follows. Each light emitting surface 104a of the light emitting diode chip 104 can face away from the first surface 101a. Each light emitting diode chip 104 can be electrically connected to the circuit structure 105 by flip-chip.

The liquid crystal display module 10 further comprises a reflecting board 108. Light emitted from the light emitting diode chip 104 is reflected by the reflecting board 108 to be incident on the first surface 101a of the thin film transistor array substrate 101.

The liquid crystal display module 10 further comprises a plurality of fluorescent covers 107. Each fluorescent cover 107 covers one light emitting diode chip 104. Light emitted from the light emitting diode chip 104 is incident on the fluorescent cover 107 and passes through the fluorescent cover 107, then is incident on the reflecting board 108, and is reflected by the reflecting board 108 to be incident on the first surface 101a of the thin film transistor array substrate 101.

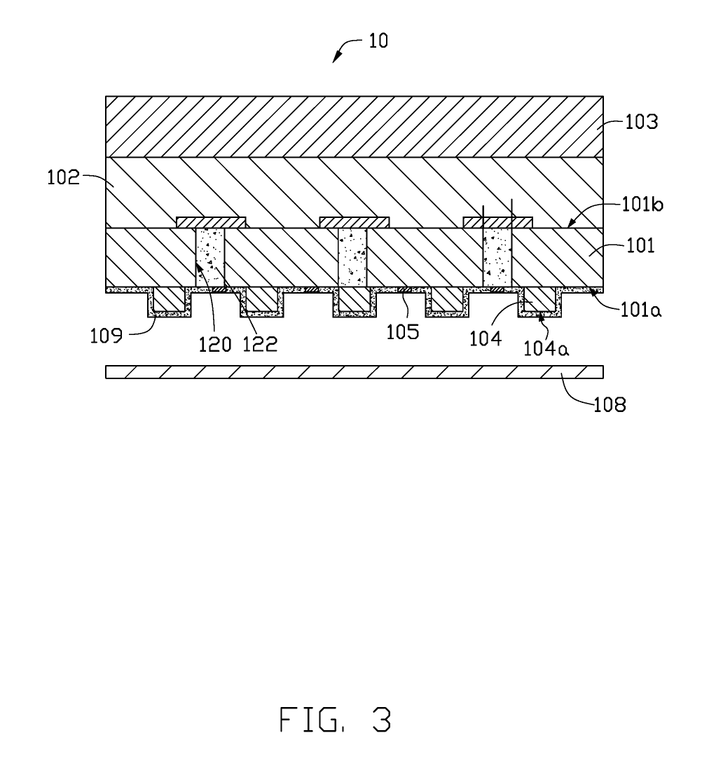

In at least one embodiment, referring to FIG. 3, the liquid crystal display module 10 of FIG. 3 differs from the liquid crystal display module 10 of FIG. 2 as follows. The plurality of fluorescent covers 107 in FIG. 2 can be replaced by a fluorescent layer 109 in FIG. 3. The fluorescent layer 109 covers the light emitting diode chips 104 and the first surface 101a of the thin film transistor array substrate 101.

The fluorescent cover 107 and the fluorescent layer 109 can be made from a light conversion layer. The light conversion layer can comprise quantum dots or at least one of R/G/B phosphors. The R phosphors are red phosphors. The R phosphors can be made of KSF (K₂(SiF₆):Mn⁴⁺), SLA(Sr(LiAl₃N₄):Eu²⁺), or SiAlON (SiAlON:Eu²⁺). The G phosphors are green phosphors. The G phosphors can be made of nitrides phosphor, oxy-Nitrides phosphor, carbo/carbido-nitrides phosphor, silicates phosphor, oxy/ortho-silicates phosphors, or CaAlSiN₃:Eu²⁺. The B phosphors are blue phosphors.

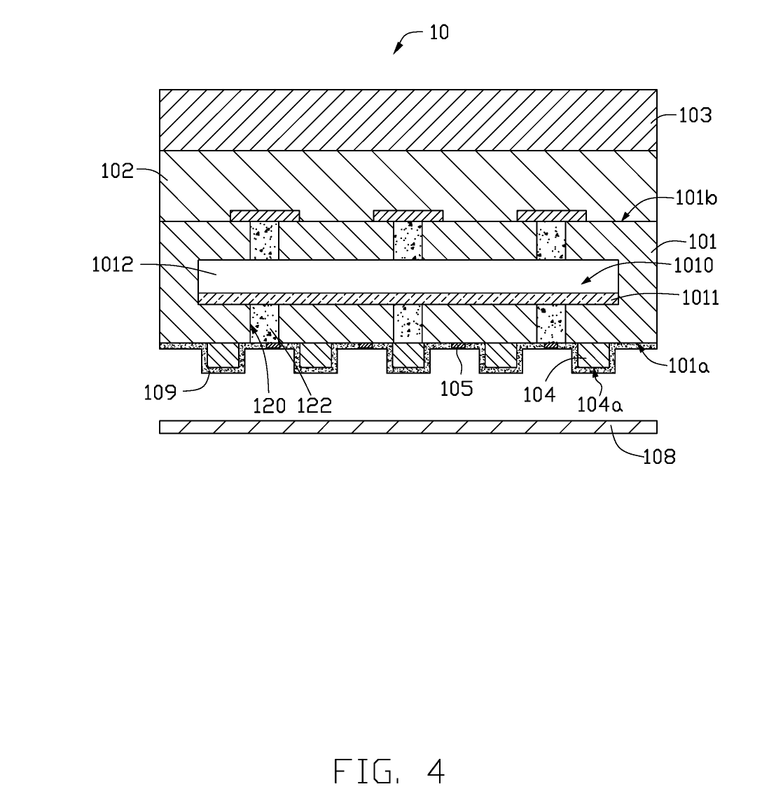

In at least one embodiment, referring to FIGS. 4-6, the thin film transistor array substrate 101 has an accommodating chamber 1010.

In at least one embodiment, referring to FIG. 4, an optical film 1011 can be received in the accommodating chamber 1010. The optical film 1011 is formed on a bottom surface 1010a of the accommodating chamber 1010. A thickness of the optical film 1011 is less than a thickness of the accommodating chamber 1010. An air layer 1012 is defined in the accommodating chamber 1010 and on the optical film 1011.

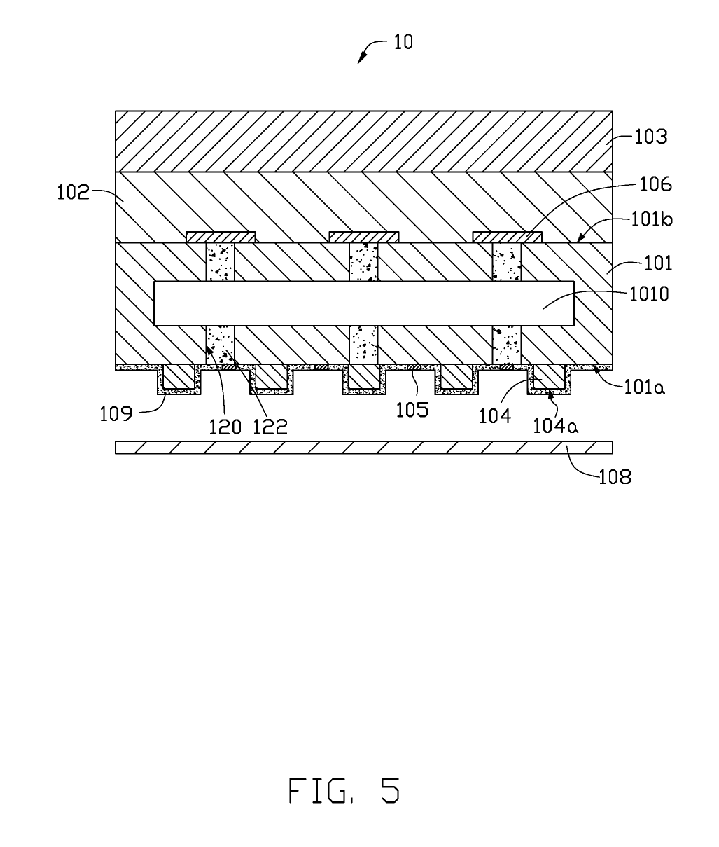

In at least one embodiment, referring to FIG. 5, the liquid crystal display module 10 of FIG. 5 differs from the liquid crystal display module 10 of FIG. 4 as follows. The accommodating chamber 1010 in FIG. 5 does not comprise the optical film 1011 in FIG. 4.

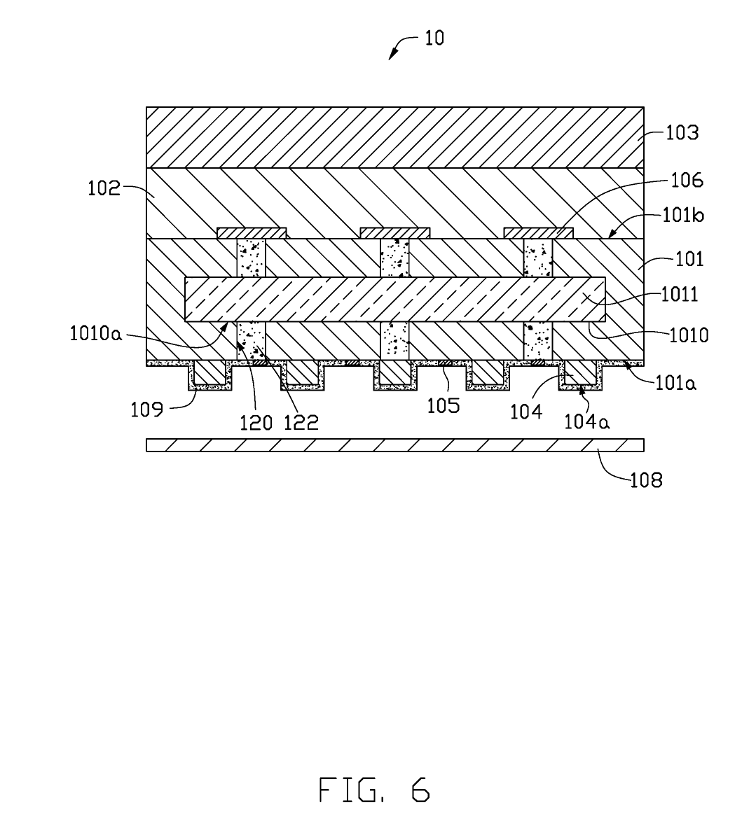

In at least one embodiment, referring to FIG. 6, the liquid crystal display module 10 of FIG. 6 differs from the liquid crystal display module 10 of FIG. 4 as follows. The accommodating chamber 1010 in FIG. 6 does not comprise the air layer 1012 in FIG. 4. The thickness of the optical film 1011 is equal to the thickness of the accommodating chamber 1010.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

1. A liquid crystal display module comprising:
a thin film transistor array substrate having a first surface and a second surface opposite to the first surface, the thin film transistor array substrate defining a plurality of holes and comprising:
a circuit structure formed on the first surface; and
a plurality of thin film transistors formed on the second surface and electrically connecting to the circuit structure by conductors received in the holes;
a liquid crystal layer facing the second surface of the thin film transistor array substrate;
a color filter substrate, the liquid crystal layer being formed between the thin film transistor array substrate and the color filter substrate; and
a plurality of light emitting diode chips adhered on the first surface and electrically connected to the circuit structure, each of the plurality of light emitting diode chips having a light emitting surface, and light emitted from the light emitting surfaces of the plurality of light emitting diode chips being incident on the first surface of the thin film transistor array substrate.

2. The liquid crystal display module of claim 1, wherein each light emitting surface of the light emitting diode chip faces the first surface.

3. The liquid crystal display module of claim 2, wherein each light emitting diode chip is electrically connected to the circuit structure by wire bonding.

4. The liquid crystal display module of claim 1, wherein each light emitting surface of the light emitting diode chip faces away from the first surface.

5. The liquid crystal display module of claim 4 further comprises a reflecting board, and light emitted from the light emitting diode chip is reflected by the reflecting board to be incident on the first surface of the thin film transistor array substrate.

6. The liquid crystal display module of claim 5 further comprises a plurality of fluorescent covers, and each of the plurality of fluorescent covers covers a corresponding one of the plurality of light emitting diode chips.

7. The liquid crystal display module of claim 5 further comprises a fluorescent layer, and the fluorescent layer covers the plurality of light emitting diode chips and the first surface of the thin film transistor array substrate.

8. The liquid crystal display module of claim 1, wherein the thin film transistor array substrate has an accommodating chamber.

9. The liquid crystal display module of claim 8, wherein an optical film is received in the accommodating chamber.

10. The liquid crystal display module of claim 9, wherein the optical film is formed on a bottom surface of the accommodating chamber.

11. The liquid crystal display module of claim 10, wherein a thickness of the optical film is less than a thickness of the accommodating chamber.

12. The liquid crystal display module of claim 11, wherein an air layer is defined in the accommodating chamber and on the optical film.

13. The liquid crystal display module of claim 10, wherein a thickness of the optical film is equal to a thickness of the accommodating chamber.
